(19) United States
(12) Patent Application Publication
(10) Pub. No.: US 2026/0161997 A1
(43) Pub. Date: Jun. 11, 2026

(54) COMPUTER-IMPLEMENTED METHOD FOR USER FALL ASSESSMENT IMPLEMENTING A TRAINED MACHINE LEARNING MODEL COMPRISING AN ACTION PLAN

(71) Applicant: Autoliv Development AB, Vargarda (SE)

(72) Inventor: Jawwad AHMED, Vargarda (SE)

(21) Appl. No.: 18/704,263

(22) PCT Filed: Oct. 28, 2022
(86) PCT No.: PCT/EP2022/080173

§ 371 Date: Apr. 24, 2024

(30) Foreign Application Priority Data
Oct. 29, 2021 (SE) 2151328-8

(51) Int. Cl. G06N 20/00; G06F 1/16

(52) U.S. Cl. CPC G06N 20/00; G06F 1/163

(57) ABSTRACT

A computer-implemented method for user fall assessment, for a fall assessment environment. The computer-implemented method comprises implementing a trained machine learning model, comprising an action plan, continuously obtaining of data, and continuously processing of data, fall assessment, in relation to a user, and validation, over time, of the action plan. The validation is based on continuous computation of fall risk probability, FRP, and monitoring if, and how, the FRP changes. If set conditions for the updating the action plan are fulfilled in the monitoring, the method comprises updating of the action plan. The fall assessment comprises fall detection, based on continuing data and on continuing information, and the continuously obtained data comprise data detected by sensors-worn by the user and positioning data for the user, The computation of FRP also comprises said positioning data.

### DESCRIPTION OF THE DISCLOSURE

The present disclosure relates to an improved computer-implemented method for user fall assessment, a computer program comprising computer readable instructions for applying the computer-implemented method, a computer program comprising computer readable instructions for a trained machine learning model, a computer program comprising computer readable instructions for a “management machine learning module”, computer readable mediums comprising the computer programs, as well as, a control unit arrangement, a device, and a system, for user fall assessment.

Falls are one leading cause of human injury and injury-related deaths. Fall detections and fall predictions are together with machine learning approaches of increased usefulness. Machine learning approaches are, for example, used today to distinguish fall and non-fall activities. At a high level, these approaches may include approaches involving vision-based arrangements which in real-time can classify falls based on live feed video. Vision-based arrangements may, in some instances, be less practical, e.g. in an outside environment, and may also come with potentially privacy issues. Further, there is also machine learning approaches focusing on more pervasive solutions being based on wearable device sensors which are non-intrusive and pervasive. In this area, see for example “A Cascade-Classifier Approach for Fall Detection, Putra et al, MOBIHEALTH 2015, October 14-16, London, Great Britain, January 2015, DOI:10.4108/eai.14-10-2015.2261619” that proposes a cascade-classifier approach for this. Other examples include the M. Musci, D. D. Martini, N. Blago, T. Facchinetti, and M. Piastra, “Fall Detection using Recurrent Neural Networks,” p. 7 as well was the F. J. González-Cañete and E. Casilari, “A Feasibility Study of the Use of Smartwatches in Wearable Fall Detection Systems,” Sensors, vol. 21, no. 6, p. 2254, Mar. 2021, doi:10.3390/s21062254.

WO2018127506A1 in the area of fall risk assessment for elderly, relates to an apparatus and a method for triggering a fall risk alert to a person. Further, in WO2018127506A1, a point in time to trigger the fall risk alert may be determined using input parameters derived from the person, and/or the environment of the person, and/or input parameters derived from further persons. WO2018127506A1 further discloses an integrated solution for adaptive multifactorial fall risk assessment, detection and prevention in elderly.

The falls may for example occur for a person walking in a home environment, or outside the home. In this context, falls also comprise falls occurring when riding a bicycle, scooter, motorcycle and the like, for example due to skidding, slipping, losing control of vehicle, crashing with another vehicle or object etc. Falls related to a running vehicle are often more abrupt, and require a faster handling than a fall occurring for a walking person that for example trips or slips.

However, there is still room for improvements in this area. In particular, regarding the requirements in the area of reliable methods for fall risk assessment.

This is achieved by means of a computer-implemented method for user fall assessment, for a fall assessment environment, where the computer-implemented method comprises implementing a trained machine learning model, comprising an action plan, continuously obtaining of data, and continuously processing of data, fall assessment, in relation to a user, and validation, over time, of the action plan. The validation is based on continuous computation of fall risk probability, FRP, and monitoring if, and how, the FRP changes.

If set conditions for the updating the action plan are fulfilled in the monitoring, updating of the action plan, wherein the fall assessment comprises fall detection, based on continuing data and on continuing information. The continuously obtained data comprise data detected by sensors worn by the user and positioning data for the user, and where the computation of FRP also comprises said positioning data.

This means that positioning data can be used to determine where falls or near falls occur, such as indoors, outdoors, stairs, slopes etc. and also if they occur in generally cold and icy environments or in generally warm environments, suitably given a time/date stamp. For a motor bike driver, the positioning data can be used to determine on which type of roads falls or near falls occur, and in which environment, for example also taking into account at least one of road surface type, road condition, traffic volume on the road all based on positioning.

According to some aspects, the computation of FRP also comprises environmental conditions, comprising weather conditions, at a determined position of the user.

This means that the real-time environmental conditions, for example in the form of weather data, can be used for the computation of FRP.

The computer-implemented method, as described herein, comprises the fall detection, based on continuing data and on the continuing information, wherein the fall detection is detected using a trained ML model which is trained using the training data collected from users, such as trainers or other wearers such as for example motorcycle and bicycle riders, using the instrumentation of 3D sensors. Once a fall is detected using the computer program it is recorded and may be used in an input to the computation of the FRP.

The computer-implemented method, as described herein, further comprises the continuous computation of FRP, based on the continuing data, FRI, and on the continuing information. The FRI comprises at least one of “skidding”, “slipping”, “losing control”, “crashing with and/or hitting another object or vehicle”, “near-falls”, “stumbles during walk”, and/or “slips”, and, optionally, other suitable key performance indicators (KPIs) for FRI.

The continuous computation of the FRP is based on the continuing data, FRI, and on the continuing information which refers to the real time information such as data collected from sensors worn by the user, or other sensor types, as well historical information, for example on the geographical environments obtained from the positioning data.

This means that the FRP is calculated using FRI: s and real time information, providing an accurate measure for FRP.

According to some aspects, the continuing information refers to information regarding user age, physical and health profile. GPS (Global Positioning System) positioning may optionally be included.

This means that the continuous computation of the FRP is based on the continuing data, continuing information and FRI:S, where the FRI:s comprises at least one of “skidding”, “slipping”, “losing control”, “crashing with and/or hitting another object or vehicle”, “near-falls”, “stumbles during walk”, and/or “slips”, where the continuing information refers to the real time information such as data collected from sensors worn by the user as well historical information on geographical environments obtained from the positioning data.

According to some aspects, the computer-implemented method comprises inducement in accordance with the action plan. The inducement comprises actuations, and preventive measures, and correlates to, and/or reflects, fall assessment in relation to a user. The fall assessment may comprise fall detection, and computation of FRP, for that specific user.

This means that preventive measures are possible, comprising counter measures to avoid a fall incident in the first place before the incident takes place.

According to some aspects, the computer-implemented method comprises the management, e.g. the continuous management, of the action plan.

The continuous computation of FRP further comprises computation of FRPt₁, at a first time t₁ and computation of FRPt₂, at a second time to being later than said first time t₁. The monitoring if, and how, the FRP changes, comprises determining the difference (Delta^{FRP}) between FRPt₁ and FRPt₂, and if Delta^{FRP} is less than, or equal to, a set FRP threshold, then the action plan is valid. If Delta^{FRP} is more than the set FRP threshold, then update the action plan.

If a significant value of Delta correlates with the significant value of an anomaly score from for example a 6 minute walk test (6MWT), then it is verified that FRP indeed has changed notably and that there is a need to update the action plan at this point.

According to some aspects, the computer-implemented method comprises the management, e.g. the continuous management, of the action plan. In the monitoring, if Delta^{FRP} is more than the set FRP threshold, then the validation is also based on employing functional status data from the user obtained at the first time t₁ and at the second time t₂ and identify any anomaly scores of the functional status from the functional status data and if identified anomaly scores is less than, or equal to, a set anomaly threshold, then the action plan is valid. the identified anomaly scores is more than the set anomaly threshold, then correlate the increased FRP with the identified anomaly scores of the functional status, and update the action plan.

According to some aspects, the computer-implemented method according to the present disclosure, as described herein, is disclosed, wherein the continuously obtained data comprise data from the fall detection.

According to some aspects, the data are obtained from one or more sensor devices worn during the user normal day to day physical activities.

Fall detection, being based on the continuing data and the continuing information, constitutes one of the key inputs to the action plan that is manually created and/or generated comprising the inducement, wherein the inducement comprises actuations and preventive measures.

According to some aspects, the computer-implemented method according to the present disclosure, as described herein, is disclosed, wherein the “management machine learning module”, during said implementation of the trained machine learning model, enables said management of the action plan, wherein the management of the action plan is a continuous management.

The computer-implemented method for user fall assessment comprises said management of the action plan, wherein the management of the action plan is a continuous management, e.g. is a continuous management and whereby the action plan may, if needed, be updated typically, periodically with a certain frequency.

According to some aspects, the management of the action plan is a continuous and automatic management. The computer-implemented method for user fall assessment comprises said management of the action plan, wherein the management of the action plan is a continuous and automatic management, e.g. is a continuous and automatic management and whereby the action plan may, if needed, be updated typically, periodically with a certain frequency.

According to some aspects, the management of the action plan is enabled by the “management machine learning module”. The present disclosure also relates to a computer programs, control units, devices, systems and pieces of garment that are associated with the above advantages.

Accordingly, it is here appreciated that the computer-implemented methods, the computer programs and the computer readable mediums, all as described herein, and in accordance with the present disclosure, may be realized in hardware, such as, the control unit arrangements and the devices, all as described herein, as well as, in the systems, as described herein. The hardware such as, the control unit arrangements and the devices, all as described herein, as well as, the systems, as described herein, are then arranged to perform the computer-implemented methods, and the computer programs, whereby the same advantages and effects are obtained as discussed for the computer-implemented methods herein.

### BRIEF DESCRIPTION OF DRAWINGS

The present disclosure will now be described more in detail with reference to the appended drawings, where:

FIG. 1 schematically illustrates a walking user wearing sensors;

FIG. 2 schematically illustrates a user who rides a motor bike and wears sensors;

FIG. 3 schematically illustrates a schematic view over aspects of “Computation of Fall Risk Probability (FRP) and Action Plan”, i.e. the computation of FRP, and the production of the action plan, both in accordance with the present disclosure;

FIG. 4 schematically illustrates a schematic view over aspects of “Verification of FRP using 6MWT” and “updating, or not updating, the Action Plan, in accordance with the present disclosure;

FIG. 5 schematically illustrates a control unit;

FIG. 6 shows an example computer program product; and

FIG. 7 shows a flowchart for methods according to the present disclosure.

### DETAILED DESCRIPTION

Aspects of the present disclosure will now be described more fully hereinafter with reference to the accompanying drawings. The different arrangements, devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

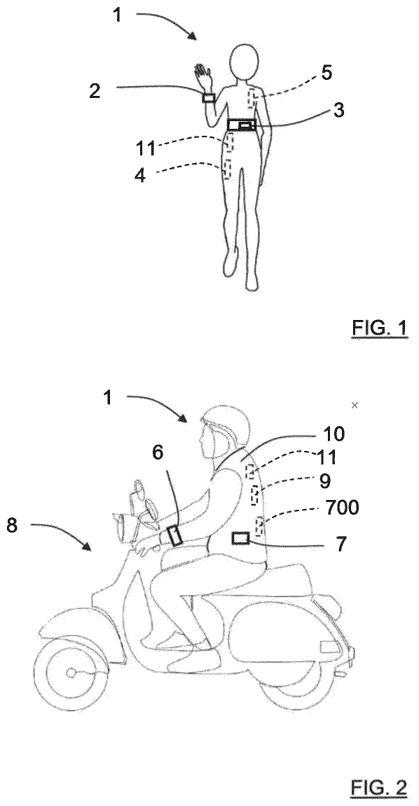

With reference to FIG. 1, there is a user 1 wearing at least one sensor device 2, 3, here one wrist sensor device 2 and one waist sensor device 3. In this case, the user 1 is walking.

With reference to FIG. 2, there is a user 1 wearing at least one sensor device, here one wrist sensor device 6 and one vest sensor device 7 comprised in a protection garment such as a protection vest 10. In this case, the user 1 is riding a motor bike 8.

The present disclosure is applicable for users that are walking or travelling on, or in, any kind of vehicle such as a bike, a motor bike 8, a car etc.

The obtained data, in accordance with present disclosure, comprise data obtained from the sensors 2, 3, 6, 7 and may also comprise data obtained from other sources. The data obtained from sensors 2, 3, 6, 7 are typically collected from, i.e. obtained from, sensors, e.g. motion sensors, comprised in, e.g. mounted on, wearable devices, for example 3d sensors, such as accelerometres to measure the acceleration in 3 dimensions, as well as, gyroscope to measure the rotational speed in 3 dimensions from a person 1, i.e. user, in accordance with present disclosure, wearing such a wearable device. The wearable devices 2, 3, 6, 7 may suitably also be edge devices.

The obtained data may comprise data obtained from other sources than sensors. The obtained data may refer to current, and past historical, data. This may include geographical positioning information of the user from GPS system as well as weather information.

According to some aspects, the user 1 wears means 1 for providing a position of the user 1 and communicating said position. Such means 11 can comprise any type of suitable positioning system, such as for example GPS or GNSS (Global Navigation Satellite Systems), and any type of wireless communication system. Said means can be comprised in a vest 11 or any suitable type of garment or wearable device.

Data collected from sensors 2, 3, 6, 7 is used as input by e.g. a fall detection computer program, i.e. fall detection according to the present disclosure and as described herein, wherein the fall detection computer program is comprised in the machine learning model, in accordance with the present disclosure and as described herein, as well as, e.g. a FRI detection computer program, i.e. FRI according to the present disclosure and as described herein, wherein the FRI detection computer program is comprised in “the machine learning model” and also in the “computation of FRP machine learning module”, both in accordance with the present disclosure and as described herein.

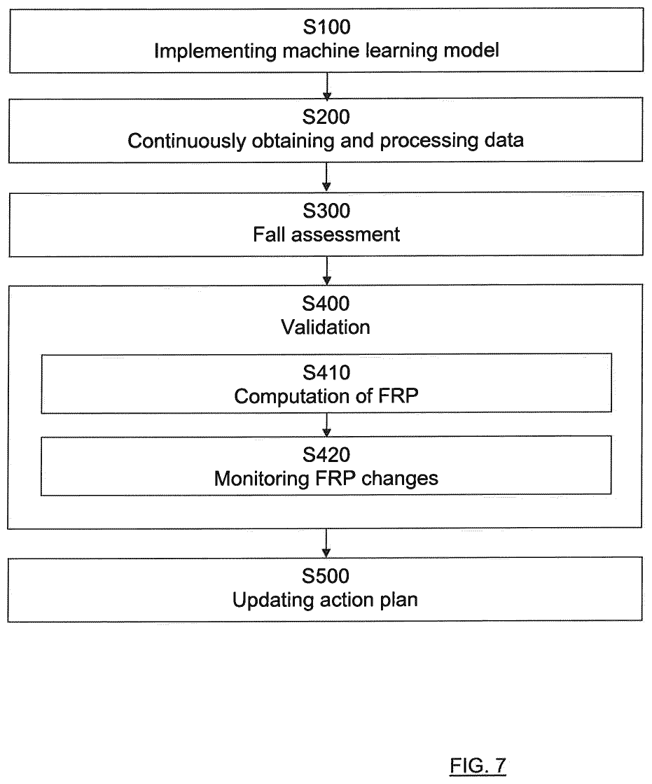

According to the present disclosure, with reference also to FIG. 7, there is a computer-implemented method for user fall assessment, for a fall assessment environment. The computer-implemented method comprises implementing S100 a trained machine learning model, comprising an action plan, continuously obtaining S200 of data, and continuously processing of data.

The method further comprises fall assessment S300, in relation to a user 1, and validation S400, over time, of the action plan. The validation S400 is based on continuous computation S410 of fall risk probability, FRP, and monitoring S420 if, and how, the FRP changes.

If set conditions for the updating the action plan are fulfilled in the monitoring, the method comprises updating S500 of the action plan. The fall assessment comprises fall detection, based on continuing data and on continuing information, and the continuously obtained data comprise data detected by sensors 2, 3, 6, 7 worn by the user 1 and positioning data for the user 1, and where the computation of FRP also comprises said positioning data.

This means that positioning data, in particular geo positioning data, can be used to determine where falls or near falls occur, such as indoors, outdoors, stairs, slopes etc. and also if they occur in generally cold and icy environments or in generally warm environments, suitably given a time/date stamp. For a motor bike driver 1, the positioning data can be used to determine on which type of roads falls or near falls occur, and in which environment.

The present disclosure is applicable for users that are walking or travelling on, or in, any kind of vehicle such as a bike, a motor bike 8, a car etc.

According to some aspects, the computation of FRP also comprises environmental conditions, comprising weather conditions, at a determined position of the user 1.

This means that the real-time environmental conditions, for example in the form of weather data, can be used for the computation of FRP.

According to some aspects, the continuous computation of the FRP is based on the continuing data, continuing information and fall risk indicators (FRI), where the FRI: s comprises at least one of “skidding”, “slipping”, “losing control”, “crashing with and/or hitting another object or vehicle”, “near-falls”, “stumbles during walk”, and/or “slips”. The continuing information refers to the real time information such as data collected from sensors 2, 3, 6, 7 worn by the user 1 as well historical information on geographical environments obtained from the positioning data.

This means that the FRP is calculated using FRI: s and real time information, providing an accurate measure for FRP. The FRP computation also takes into account non-real-time (offline) information such as from historical/past information about the user and current environment.

According to some aspects, the continuously obtained data comprise data from the fall detection. According to some aspects, the data are obtained from one or more sensor devices 2, 3, 6, 7 worn during the user 1 normal day to day physical activities.

According to some aspects, the computer-implemented method, as described herein, comprises the fall detection, based on continuing data and on the continuing information, wherein the fall detection is detected using a trained ML model which is trained using the training data collected from users 1, such as trainers or other wearers, such as for example motorcycle and bicycle riders, using the instrumentation of 3D sensors. Once a fall is detected using the computer program it is recorded and may be used in an input to the computation of the FRP.

According to some aspects, as described herein, the action plan may be based on the historical actual falls, as well as, FRPs namely the individual human/user FRPs and FRPs associated with the geo position. Fall risk probability (FRP) itself is computed using the fall risk indicators (FRI) such as “skids” “near-falls”, “stumbles during walk”, ‘slips’ in certain time-period (and possibly other similar KPIS). Geo-positioning FRPS (calculated by sharing of geo locations and fall frequency). Note that FRPs impact the creation/generation of the action plan. As an example an increased FRP for a user might dictate the use of more stringent actuation plan such as a higher spec version of portable airbag with more inflation volume as well higher inflation rate if triggered.

The obtained data, in accordance with aspects of the present disclosure, may according to some aspects comprise data obtained from other sources than sensors, for example, data such historical data of user age, health profile, weather forecasts, positioning information of the user from GPS (Global Positioning System).

This means that the continuous computation of the FRP is based on the continuing data, continuing information and FRI:S, where the FRI:s comprises at least one of “skidding”, “slipping”, “losing control”, “crashing with and/or hitting another object or vehicle”, “near-falls”, “stumbles during walk”, and/or “slips”, where the continuing information refers to the real time information such as data collected from sensors worn by the user as well historical information on geographical environments obtained from the positioning data.

The fall assessment comprises the fall detection, and the computation of the FRP, or the fall detection, and computation of the FRP and FRP associated with the geo position.

The fall detection historical data is one of the inputs for creating/generating a suitable action plan for a user.

In aspects of the present disclosure, as described herein, a further input to the computation of a suitable action plan is computed FRPs e.g. the FRPS, for example the human FRPs, and geo-position based FRPs. For example, FRP can be computed for geographical regions based on geo-position.

The computer-implemented method for user fall assessment, as described herein, comprises continuously obtaining of data, and continuously processing of data, continuous creation of information on basis of the obtained data and the processed data, and continuous communication of the information.

The computer-implemented method, as described herein, comprises the continuously obtaining of data and continuously processing of data, wherein the obtained data comprise data obtained from sensors and may also comprise data obtained from other sources. The data enables the computation of FRP and FRI, and FRP itself is computed using FRI.

The data obtained from sensors are typically obtained from sensors comprising, for example, motion sensors, 3D sensors, accelerometers, gyroscopes and/or cameras, e.g. motion sensors, 3D sensors, accelerometers and/or gyroscopes. The sensors may, for example, be wearable sensors, e.g. comprising motion sensors, 3d sensors, accelerometers and/or gyroscopes. The sensor data may be obtained from sensors, for example, wearable sensors, e.g. comprising motion sensors, 3D sensors, accelerometers and/or gyroscopes. Wearable device comprises 3D sensors being accelerometres may be used to measure acceleration in 3 dimensions, and wearable device comprises 3D sensors being gyroscope may be used to measure rotational speed in 3 dimensions, from a person, i.e. a user in accordance with present disclosure, wearing such a wearable device. The wearable devices may suitably also be edge devices.

The computer-implemented method, as described herein, comprises the continuously processing of data, wherein FRI is computed over time using the trained ML algorithm, i.e. the trained ML computer program, which is trained on training data to detect fall risk indicators (FRI) such as “skids”, “near-falls”, “stumbles during walk”, ‘slips’ in certain time-period (and other KPIS). These FRIs form the input basis to the computation of FRP.

Further, the computer-implemented method comprises the continuous creation of the information on basis of the obtained data and the processed data, e.g. information and data such as the detection and recording of falls, FRIs as well as computation of FRPs which are eventually used for the creation/generation of an action plan for actuation and preventive measures.

The computer-implemented method for user fall assessment, as described herein, comprises fall assessment, in relation to a user, wherein the fall assessment comprises fall detection, based on continuing data and on the continuing information, and continuous computation of FRP, based on the continuing data, fall risk indicators (FRI), and on the continuing information.

According to some aspects, the computer-implemented method further comprises inducement in accordance with the action plan, wherein the inducement comprises actuations, and preventive measures, and correlates to, and/or reflects, fall assessment in relation to a user.

According to some aspects, the inducement comprises the actuations and the preventive measures, wherein the actuations here refer to actions performed, and/or to be performed, in accordance with the computer-implemented method for user fall assessment, as described herein, and in accordance to the action plan, which comprise actions performed, and/or to be performed, by a suitable product to minimize any injury after a fall incident has occurred (and where as a, so called, point of no-return has been reached).

With reference also to FIG. 1 and FIG. 2, said actuations may include, e.g. a mechanical actuation of a portable airbag 4, 5; 9 after, for example, detection of a fall incident. The safety capabilities of the portable airbag 4, 5; 9, and properties such as volume, inflation capacity and inflation rate of the airbag 4, 5; 9, is based on the action plan, and on the inducement in accordance to the action plan. The inducement comprises actuations, and preventive measures, and correlates to, and/or reflects, fall assessment in relation to a user, wherein the fall assessment comprises fall detection, and computation of FRP, for that specific user.

In aspects of the present disclosure, as described herein, the inducement comprises actuations, and preventive measures, and correlates to, and/or reflects, fall assessment in relation to a user, wherein the fall assessment comprises fall detection, and computation of FRP in conjunction with geographic (geo) positioning of a GPS, for that specific user.

Input to the manual creation of the action plan and/or the generation of the action plan, comprises input from the fall assessment comprising fall detection and computation of FRP, and may also comprise input from the fall assessment comprising fall detection and computation of FRP in conjunction with geo positioning of a GPS, e.g. of a user currently utilizing GPS.

Further, the preventive measures refer to counter measures to avoid a fall incident in the first place before the incident takes place. The preventive measures include, but are not limited to, actual alerts, for example visual, audible, and or haptic alerts, etc., to the user/s if a posture is detected that is a posture in a dangerous position e.g. being close to fall (but where a point of no return has still not been reached).

Further, the preventive measures may also include, other physical preventive measures such as increased protective clothing and/or protective gear for the user/s, and/or may even include increased monitoring of the user/s. Further, these preventive measures are also based on the fall assessment wherein the fall assessment comprises fall detection, and computation of FRP for the specific user, and may also, as described herein, comprise the computation of FRP in conjunction with geo positioning of a GPS, e.g. of FRP in conjunction with geo positioning of a user currently utilizing GPS.

According to some aspects, preventive measures include warning signals and protective measures include inflation of one or more protection airbags 4, 5; 9 as illustrated in FIG. 1 and FIG. 2. As shown in FIG. 2, for a person or user 1 riding a motor bike 8 or similar, sensors 6, 7, control units 700 and/or protection airbags 9 can all be comprised in a protection garment such as a protection vest 10.

Further, input to the generation of also a new, and/or updated, action plan comprises input from the fall assessment, i.e. from fall detection and computation of FRP for the specific user, and optionally also, from the computation of FRP in conjunction with geo positioning of a user currently utilizing GPS.

In aspects of the present disclosure, as described herein, the action plan may be based on the historical actual falls, as well as, FRPs namely the individual human/user FRPs and FRPs associated with the geo position. Fall risk probability (FRP) itself is computed using the fall risk indicators (FRI) such as “skids”, “near-falls”, “stumbles during walk”, ‘slips’ in certain time-period (and possibly other similar KPIS). Geo-positioning FRPs (calculated by sharing of geo locations, fall frequency and information of a user fall or near fall incident on that geo-location or region). Note that FRPs impact the creation/generation of the action plan. As an example an increased FRP for a user might dictate the use of more stringent actuation plan such as a higher spec version of portable airbag with more inflation volume as well higher inflation rate if triggered.

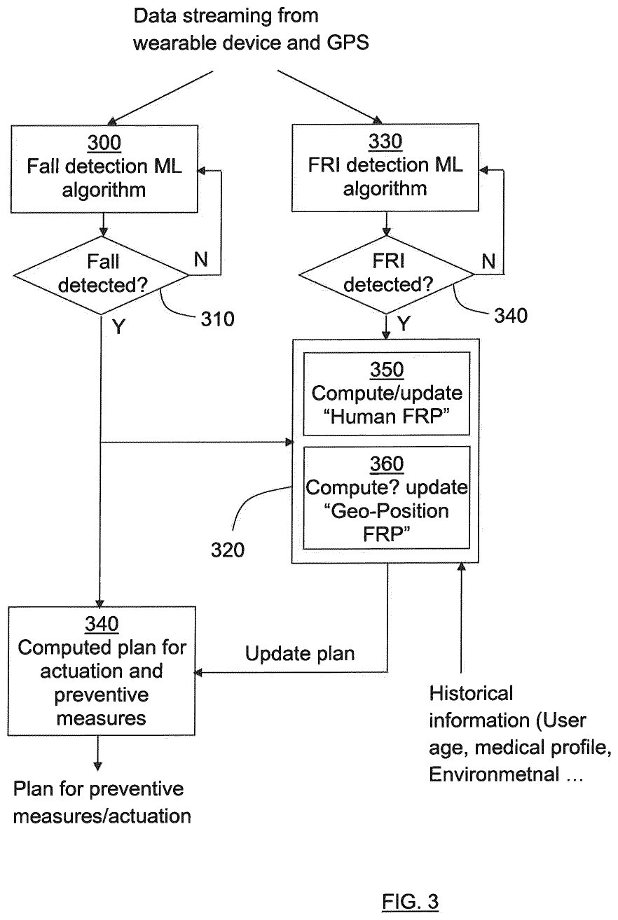

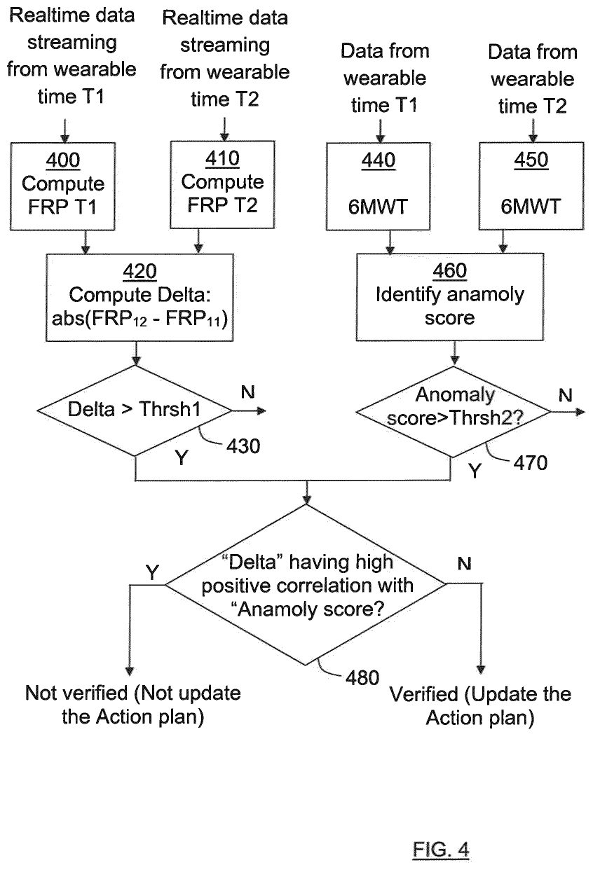

It is now referred to FIG. 3 and FIG. 4 for the following description of examples according to some aspects of the present disclosure.

In FIG. 3 it is depicted on how to compute the FRP i.e. computation of FRP according to some aspects of the present disclosure and as described herein, and generation of the action plan, i.e. production of the action plan here comprising generation of the action plan reflecting the training of the machine learning model according to the present disclosure and as described herein.

Production, such as the generation, of the action plan of the present disclosure, includes the computation of the Plan for Actuation and Preventive measures, i.e. the generation of the action plan of the present disclosure as described herein. Data is streamed and collected, i.e. is obtained, from sensors 2, 3, 6, 7 such as 3D sensors mounted on wearables as well as positioning information from such as GPS, see “Data streaming from wearable device+GPS” in FIG. 3.

Said obtained data is processed and then fed to the trained Fall Detection algorithm 300, i.e. the trained fall detection computer program. Fall detection algorithm i.e. fall detection computer program, and fall detection according to the present disclosure, is trained using the training data collected from the user/s, such as the trainers and other wearers, during the fall training sessions, see “Fall detected?” 310 in FIG. 3, “Y” means fall detected, and “N” means no fall detected, see FIG. 3.

Predictions and associated prediction probabilities from the Fall Detection algorithm can be stored and updated to an offline database. This forms one of the input information signals to an Action Plan computation block i.e. to the generation of the action plan of the present disclosure.

In parallel there is another algorithm, i.e. another computer program, FRI Detection algorithm 330, i.e. FRI Detection computer program, and FRI being a basis to the continuous computation of FRP of the present disclosure as described herein, which also receives the 3D sensor data and predicts and records/updates the different FRIs as they occur in a database, see “FRI Predicted?” 340 in FIG. 3, “Y” means FRI predicted, and “N” means no FRI predicted, see FIG. 3. Note that depending on the actual implementation it may be that both Fall Detection and FRI Detection functionalities i.e. the fall detection, and FRI being a basis to the computation of FRP, according to the present disclosure, are provided by single algorithm, i.e. single computer program, or they could be implemented separately. But this is an implementation detail only. Predicted FRIs both historical as well more recent information from the database, see “FRI Predicted?” and “Y” in FIG. 3, together with the historical information about the user age, health profile, medical profile and environmental information such as weather, see “Historical information (User Age, health, medical profile), Environmental ” in FIG. 3, are then fed to the block 320, i.e. the “computation of FRP machine learning module” 320, in accordance with the present disclosure and as described herein, which block computes the FRP for both individual user/s, see “Compute/Update ”Human FRP“ ” 350 in FIG. 3, as well as optionally for the geo positioning or regions, see “Compute? Update “Geo-Position FRP”” 360 in FIG. 3.

Both type of FRP computations take into account the information from detected FRIs (current and past recorded in database) and then computes a FRP for the user and potentially also for the geo positions. Finally based on the information on the detected fall and computed FRP an Action Plan is generated, i.e. production of the action plan the action plan according to the present disclosure and as described herein, customized for each user for preventive and actuation measures, see “Update Plan”, “Computed Plan for Actuation and Preventive measures” 370 and “Plan for Preventive Measures/Actuation”, in FIG. 3.

According to some aspects, FIG. 4 shows one possible verification approach for the computed (user) FRP, i.e. the “validation is based on: the continuous computation of FRP”, in accordance with the present disclosure and as described herein, (from “the validation, over time, of the action plan” of the present disclosure). The computed (user) FRP as shown earlier in FIG. 3. However, this is an example and similar approach can be used to verify the change in FRP using other standard medical tests other than a 6 minutes walking test (6MWT). The 6 Minute Walk Test (6MWT) , as disclosed herein, is a sub-maximal exercise test used to assess aerobic capacity and endurance. The distance covered over a time of 6 minutes is used as the outcome by which to compare changes in performance capacity.

FIG. 4 shows that FRP is to be computed at different time intervals namely t1 and then t2 (see “Compute FRP T1” 400 and “Compute FRP T2” 410 in FIG. 4), i.e. computation of FRPt₁, at a first time t₁ and computation of FRPt₂ at a second time t₂, as described herein. FRP is computed from data obtained from sensors, as described herein, see “Realtime Data streaming from wearable time T1” and “Realtime Data streaming from wearable time T2” in FIG. 4.

Then, the Delta difference in FRP is computed (see “Compute Delta: abs(FRP_{T2}−FRP_{T1})” 420 in FIG. 4), i.e. determining the difference (Delta^{FRP}), as described herein, which is to be compared then to predefined threshold1 (see “Delta>Thrsh1” 430, “Y” (yes) and “N” (no) in FIG. 4), i.e. comparing Delta^{FRP} with a set FRP threshold, in accordance with the present disclosure, as described herein.

According to some further aspects, for the same time-periods t1, and t2, results from 6MWT 440, 450 can also be computed, i.e. also being based on employing functional status data from the user obtained at the first time ti and at the second time t₂, in accordance with the present disclosure, as described herein, and compared to identify an anomaly score 460, see FIG. 4 (see also “Anomaly Score>Thrsh 2” 470, “Y” (yes) and “N” (no) in FIG. 4), (change in score between two different time instances), i.e. identify any anomaly scores of the functional status, in accordance with the present disclosure, as described herein.

Furthermore, if both delta are greater than their respective thresholds, i.e. if both Delta^{FRP} and “identified anomaly scores” are greater than set FRP threshold and set anomaly threshold, respectively, and as described herein, then a check 480 is made to make sure that both changes are positively correlated. If it is then verified that FRP has changed sufficiently there is a need to update the Action Plan, otherwise the Action Plan does not need to be updated, i.e. comprised in management of the action plan, in accordance with the present disclosure and as described herein, here see also ““Delta” having high positive correlation with “Anomaly Score”?” 480, “Y” (yes), “Verified (update the Action Plan)”, “N” (no) and “Not Verified (Not update the Action Plan)”, in FIG. 2.

Note that this shows the FRP verification for the users but the same concept can easily be adopted optionally to verify the FRP for the geo position or regions at different time intervals.

According to some aspects, the computer-implemented method comprises the management of the action plan. The continuous computation of FRP further comprises computation of a first FRP, FRPt₁, at a first time, t₁, and computation of a second FRP, FRPt₂, at a second time, t₂, being later than said first time t₁. The monitoring if, and how, the FRP changes, comprises determining a difference, Delta^{FRP}, between FRPt₁ and FRPt₂, and if Delta^{FRP} is less than, or equal to, a set FRP threshold, then the action plan is valid, and if Delta^{FRP} is more than the set FRP threshold, then update the action plan.

According to some aspects, the computer-implemented method according to the present disclosure, as described herein, is disclosed, wherein the “management machine learning module”, during said implementation of the trained machine learning model, enables the management, e.g. the continuous management, of the action plan. The continuous computation of FRP further comprises computation of FRPt₁, at a first time t₁ and computation of FRPt₂, at a second time to being later than said first time t₁.

The monitoring if, and how, the FRP changes, comprises determining the difference (Delta^{FRP}) between FRPt₁ and FRPt₂, and if Delta^{FRP} is less than, or equal to, a set FRP threshold, then the action plan is valid, and if Delta^{FRP} is more than the set FRP threshold, then update the action plan (i.e. this means the FRP has changed beyond the set FRP threshold, and then there is a need to update the action plan.

Further, note that if there is a need for the action plan to be updated after computing the Delta^{FRP} value then a further verification can be done to compute an anomaly score based on a 6 Minute Walk Test (6MWT) results at said first time t₁ and said second time t₂. If a significant value of Delta correlates with the significant value of the anomaly score from the 6MWT then it is verified that FRP indeed has changed notably and that there is a need to update the action plan at this point.

According to some aspects, the computer-implemented method comprises the management of the action plan. In the monitoring, if Delta^{FRP} exceeds the set FRP threshold, then the validation is also based on employing functional status data from the user obtained at the first time t₁ and at the second time t₂ and identify any anomaly scores of the functional status from the functional status data and if identified anomaly scores is less than, or equal to, a set anomaly threshold, then the action plan is valid. If the identified anomaly scores is more than the set anomaly threshold, then correlate the increased FRP with the identified anomaly scores of the functional status, and update the action plan.

According to some aspects, the computer-implemented method according to the present disclosure, as described herein, is disclosed, wherein the “management machine learning module”, during said implementation of the trained machine learning model, enables the management, e.g. the continuous management, of the action plan. The monitoring, if Delta^{FRP} is more than the set FRP threshold, then the validation is also based on employing functional status data from the user obtained at the first time t₁ and at the second time t₂ and identify any anomaly scores of the functional status from the functional status data and if identified anomaly scores is less than, or equal to, a set anomaly threshold, then the action plan is valid. If the identified anomaly scores is more than the set anomaly threshold, then correlate the increased FRP with the identified anomaly scores of the functional status, and update the action plan.

According aspects, the computer-implemented method according to the present disclosure, as described herein, is disclosed, wherein continuously obtained data comprise positioning data, e.g. geographic positioning data. The computation of FRP also comprises positioning data, e.g. geo positioning data. FRP can also calculated for the geo positioning using FRI, as described herein, with an additional tag depicting the geo position (e.g. using GPS) of where the FRI have occurred. This will in turn allow for computation of FRP for geo positions or for geo regions.

Further, to be able to develop such information in an efficient way it may be required to have a mechanism for sharing relevant information/data between entities in a collaborative way. One way to do this is that each of the entities may “opt-in” to share relevant information/data of the FRI to a central entity which central entity then computes the FRP associated with each “geo position”/“geo region” and then share this information to all the entities in the collaborative system, i.e. to all the entities that have “opted-in”.

According to some aspects, the management of the action plan is a continuous management, and the computer-implemented method for user fall assessment comprises said management of the action plan, wherein the management of the action plan is a continuous management.

It is to be appreciated that for all embodiments disclosed herein, FIG. 6 discloses a general representation of a computer program 810 comprising computer readable instructions 820 on a computer readable medium 830. The computer program may according to some aspects be regarded as a computer program product.

The present disclosure also relates to a computer program 810 comprising computer readable instructions 820 for applying the computer-implemented method, as described herein, and/or a computer readable medium 830 comprising said computer program 810.

The present disclosure also relates to a computer program 810 comprising computer readable instructions 820 for a trained machine learning model, as described herein, and/or a computer readable medium 830 comprising said computer program 810.

The present disclosure also relates to a computer program 810 comprising computer readable instructions 820 for “management machine learning module”, as described herein, and/or a computer readable medium 830 comprising said computer program 810.

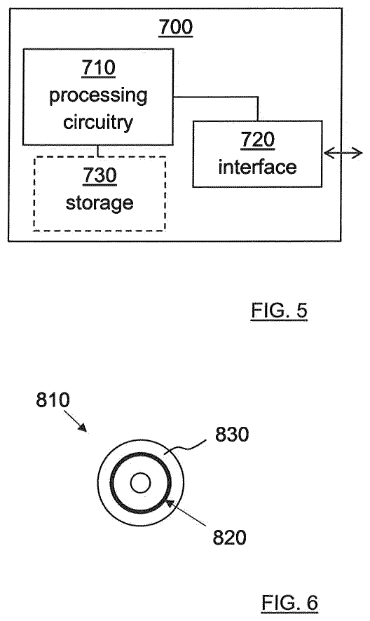

Further, with reference to FIG. 5, the present disclosure also relates to a control unit arrangement 700, for user fall assessment, adapted to control at least, enablement of: implementation of the trained machine learning model, as described herein, the inducement in accordance to, and/or the management, of the action plan, as described herein. The control unit arrangement 700 is in the following referred to as a control unit 700.

FIG. 5 schematically illustrates, in terms of a number of functional units, the components of the control unit 700 according to an embodiment.

Processing circuitry 710 is provided using any combination of one or more of a suitable central processing unit (CPU), multiprocessor, microcontroller, digital signal processor (DSP), dedicated hardware accelerator, etc., capable of executing software instructions stored in a computer program product, e.g. in the form of a storage medium 730. The processing circuitry 710 may further be provided as at least one application specific integrated circuit (ASIC), or field programmable gate array (FPGA).

Particularly, the processing circuitry 710 is configured to cause the control unit 700 to perform a set of operations, or steps. These operations, or steps, were discussed above in connection to the various radar transceivers and methods. For example, the storage medium 730 may store the set of operations, and the processing circuitry 710 may be configured to retrieve the set of operations from the storage medium 730 to cause the control unit 700 to perform the set of operations. The set of operations may be provided as a set of executable instructions. Thus, the processing circuitry 710 is thereby arranged to execute methods and operations as herein disclosed.

The storage medium 730 may also comprise persistent storage, which, for example, can be any single one or combination of magnetic memory, optical memory, solid state memory or even remotely mounted memory.

The control unit 700 may further comprise a communications interface 720 for communications with at least one other unit. As such, the communications interface 720 may comprise one or more transmitters and receivers, comprising analogue and digital components and a suitable number of ports for wired or wireless communication.

The processing circuitry 710 is adapted to control the general operation of the control unit 700 e.g. by sending data and control signals to the external unit and the storage medium 730, by receiving data and reports from the external unit, and by retrieving data and instructions from the storage medium 730. Other components, as well as the related functionality, of the control unit 700 are omitted in order not to obscure the concepts presented herein.

The present disclosure also relates to a device, e.g. a wearable

device, for user fall assessment, for communication of information, for enabling implementation of the trained machine learning model, wherein the trained machine learning model is as described herein, and for inducement in accordance to, and for enabling management, of the action plan, wherein the action plan is as described herein. The inducement comprises actuations, and preventive measures, where the fall assessment comprises fall detection and computation of FRP based on continuously obtained data and FRI, and wherein the FRI comprises FRI:s such as “skidding”, “slipping”, “losing control”, “crashing with and/or hitting another object or vehicle”, “near-falls”, “stumbles during walk”, and/or “slips”.

The device comprises the trained machine learning model being trained in the user fall assessment and comprising an action plan, sensor/s detecting data, means for continuously obtaining data, means 700 for processing data, means for creating the information on basis of obtained data and processed data, and means for communicating the information. The device comprises the computer program/s 810 comprising computer readable instructions 820 according to the above and/or the computer readable medium/s 830 according to the above.

According to some aspects, the device is at least partly in the form of a vest 10 or similar garment. The device can also be constituted by a control unit arrangement 700 and/or a bracelet or similar. In FIG. 1, a user 1 is shown hearing a sensor 2 that is comprised in a bracelet. Generally, the present disclosure relates to a 15 a piece of garment 10 comprising the control unit arrangement 700 as described herein, one or more sensors 2, 3, 6, 7 detecting data as described herein, and at least one airbag 4, 5, 9.

According to some aspects, the computer program 810 is used for applying the computer-implemented method, as described herein; for a trained machine learning model, as described herein; and/or for a “management machine learning module”, as described herein; and computer readable medium/s comprising said computer program/s.

The present disclosure also relates to a system for user fall assessment, for communication of information, for enabling implementation of the trained machine learning model, wherein the trained machine learning model is as described herein, and for inducement in accordance to, and for enabling management, of the action plan, wherein the action plan is as described herein; wherein the inducement comprises actuations, and preventive measures. The fall assessment comprises fall detection and computation of FRP based on continuously obtained data and FRI, and wherein the FRI comprises FRI: s such as “skidding”, “slipping”, “losing control”, “crashing with and/or hitting another object or vehicle”, “near-falls”, “stumbles during walk”, and/or “slips”.

The system comprises a trained machine learning model being trained in the user fall assessment and comprising an action plan, sensor/s detecting data, means for continuously obtaining data, means for processing data, means for creating the information on basis of obtained data and processed data, and means for communicating the information. The system comprises computer program/s 810 comprising computer readable instructions 820 for applying the computer-implemented method, as described herein and/or the computer readable medium 830 according to as described herein.

According to some aspects, the computer program 810 is used for applying for a trained machine learning model, as described herein; and/or for a “management machine learning module”, as described herein; and computer readable medium/s comprising said computer program/s.

According to some aspects, the “management machine learning module”, during said implementation of the trained machine learning model, enables said management of the action plan, wherein the management of the action plan is a continuous management, and the computer-implemented method for user fall assessment comprises said management of the action plan, wherein the management of the action plan is a continuous management.

According to some aspects, the fall assessment environment comprises the trained machine learning model being trained in user fall assessment, the user, sensors detecting data from the fall assessment environment, means for continuously obtaining data, means for processing data, means for creating the information on the basis of obtained data and processed data; means for communicating the information, and means for the inducement in accordance to the action plan and based on continuing data and based on the information.

According to some aspects, the trained machine learning model, during its implementation in the computer-implemented method for user fall assessment, continuously enables the continuous obtaining of data and the continuous processing of data, the continuous creation, and the continuous communication, of the information, the fall assessment, in relation to the user, comprising the fall detection and the continuous computation of FRP, and the inducement in accordance to the action plan.

In aspects of the present disclosure, as described herein, production of the action plan comprises manual creation of the action plan specifying inducement correlating to fall assessment in relation to the user, and/or production of the action plan comprises generation of the action plan reflecting the training of the machine learning model, wherein the inducement reflects the fall assessment in relation to the user. Alternatively, creation/update of the action plan can also be automatic.

Further, in accordance with aspects of the computer-implemented method for user fall assessment, as described herein, the fall assessment comprises fall detection and computation of fall risk probability (FRP).

The continuous computation of the FRP may, for example, be an automatic and continuous computation of FRP.

According to some aspects, the FRI over time are detected and recorded per user using the trained ML model. This may form the basis for the computation of the FRP. Note that for the computation of the FRP from the FRI the individual FRI can also be weighted such as giving higher weightage to the FRI being “skids”, “stumbles during walk” as compared to the “slips”. As “slips” might be because of the road and environmental conditions while “stumbles during walk” may indicate other medical issues. “Skids” are due to road and environmental conditions for a motor bike 8.

According to some further aspects, the FRI comprises FRI: s such as “skidding”, “slipping”, “losing control”, “crashing with and/or hitting another object or vehicle”, “near-falls”, “stumbles during walk”, and/or “slips”, and may, optionally, comprise other suitable key performance indicators (KPIs) for FRI.

Further, note that FRI may also not be limited to the ones listed above but may also optionally include other KPIs as well depending on the individual use case and scenario.

The continuously obtained data, and the continuously processed data, according to some aspects comprise data detected by sensors, FRI, and data in relation to FRI, and may, optionally also comprise other data e.g. from weather forecast from internet.

Further, according to some aspects, for a fall assessment environment. The fall assessment environment comprises the trained machine learning model being trained in the user fall assessment, the user, sensors detecting data from the fall assessment environment, means for continuously obtaining data; means for processing data, means for creating the information on basis of obtained data and processed data, means for communicating the information, and means for the inducement in accordance to the action plan based on continuing data and based on the information.

The trained machine learning model being trained in the user fall assessment, wherein the fall assessment comprises fall detection, and computation of FRP comprising detection of the FRIs of the user, i.e. the training may according to some aspects be considered to include several types of ML model, and ML model trainings. For example, a model being trained for the fall detection and the second model being trained for the computation of FRP comprising the detection of the FRIs of the user.

According to some aspects, the sensors 2, 3, 6, 7 detecting data comprise sensors detecting data in relation to the user, e.g. from sensors on, or at, the user, and, optionally, also further sensors detecting data in, or in relation to, said environment. Further, the sensors comprise, for example, fall sensors, motion sensors and position sensors, e.g. global positioning system (GPS), and optionally further sensors in said environment. In further embodiments, the sensors comprise, for example, fall sensors and motion sensors.

The means for continuously obtaining data may according to some aspects be any means suitable for continuously obtaining data. The obtained data comprise “data detected by the sensors”, FRI, and data in relation to FRI.

Further, according to some aspects, the obtained data comprise “data detected by the sensors”, FRI, and data in relation to FRI, and, optionally other data e.g. from weather forecast from internet.

The means for creating the information on basis of obtained data, and processed data, may according to some aspects comprise any means suitable for creating the information.

The means for communicating the information may according to some aspects comprise any means suitable for communicating the information.

Further, the means for the inducement in accordance to the action plan, based on the continuing data and based on the information, may according to some aspects comprise any means suitable for the inducement.

According to some aspects, the trained machine learning model continuously enables, during its implementation in the computer-implemented method for user fall assessment, as described herein:
the continuous obtaining of data and the continuous processing of data,
the continuous creation, and the continuous communication, of the information,
the fall assessment, in relation to the user, comprising the fall detection and the continuous computation of FRP, and
the inducement in accordance to the action plan.

According to some aspects, the computer-implemented method for user fall assessment, as described herein, further comprises that the trained machine learning model comprises a “computation of FRP machine learning module”, wherein the “computation of FRP machine learning module”, during said implementation of the trained machine learning model, enables the continuous computation of FRP.

According to some aspects, the trained machine learning model further comprises a “management machine learning module”, wherein the “management machine learning module”, during said implementation of the trained machine learning model, enables management, e.g. the continuous management, of the action plan,

For example, the management comprises validation, over time, of the action plan, wherein the validation is based on: the continuous computation of FRP, monitoring if, and how, the FRP changes, and, if set conditions for updating the action plan are fulfilled in the monitoring, updating the action plan.

According to some aspects, the computer-implemented method for user fall assessment further comprises the management, e.g. the continuous management, of the action plan. For example, the management comprises the validation, over time, of the action plan. The validation is based on the continuous computation of FRP, the monitoring if, and how, the FRP changes, and, if set conditions for the updating the action plan are fulfilled in the monitoring, the updating of the action plan.

According to some aspects, the “computation of FRP machine learning module” enables, during said implementation of the trained machine learning model, the continuous computation of FRP.

According to some aspects, the “management machine learning module” enables, during said implementation of the trained machine learning model, management, e.g. continuous management, of the action plan, wherein the management comprises: validation, over time, of the action plan, wherein the validation is based on: the continuous computation of FRP, monitoring if, and how, the FRP changes, and, if set conditions for updating the action plan are fulfilled in the monitoring, updating the action plan.

The validation, and the continuous computation of FRP, may according to some aspects further also be based on positioning data.

The validation, and the continuous computation of FRP, may according to some aspects further also be based on positioning data and/or on the fall detection data.

According to some aspects, the computer-implemented method for user fall assessment, as described herein, provides a customized action plan comprising actuations and preventive measures, wherein the action plan is based on each user needs, wherein the needs are based on the user's current, and past, circumstances of detected falls and fall risk probability using the detected fall risk indicators. This will have an effect of allowing an improved action plan comprising a boosted protection for the users which are more vulnerable to falls based on an estimation of the computer-implemented method for user fall assessment, as described herein. The estimation of the computer-implemented method for user fall assessment also may be updated over time. Further, the improved action plan may according to some aspects also allow for toning down protection plan for users not being as much prone to falls based on a current estimation of the computer-implemented method for user fall assessment In essence the action plan for each user can be optimized and updated over time according to changing needs rather than a “one solution fits all”. Further, note that FRP may also be associated not just with the user but also with geo positioning hence the geo positioning may also influence the action plan generated for each user. Furthermore, the action plan can also be updated dynamically over time with a certain frequency. Looking from another perspective the proposed computer-implemented method for user fall assessment, as described herein, allows for an improved use and allocation limited physical resources (e.g., protective equipment, and/or fall and/or protection equipment) and human resources (close observation and monitoring of individuals') at certain facilities such as adult care homes based on each needy user's needs, e.g. person's/patient's needs.

According to some aspects, the management, e.g. the continuous management, of the action plan, comprises the validation, over time, of the action plan, wherein the validation is based on the continuous computation of FRP.

According to some aspects, the management, e.g. the continuous management, comprises the validation, over time, of the action plan, wherein the validation is based on: the continuous computation of FRP.

The management, e.g. the continuous management, comprises the validation, over time, of the action plan, wherein the validation, and the continuous computation of FRP, may according to some aspects further also be based on positioning data.

According to some aspects, the management, e.g. the continuous management, comprises the validation, over time, of the action plan, wherein the validation, and the continuous computation of FRP, may further also be based on positioning data and/or on the fall detection data.

According to some aspects, the computer-implemented method for user fall assessment, as described herein, further comprises the monitoring if, and how, the FRP changes, and, if set conditions for the updating the action plan are fulfilled in the monitoring, the updating of the action plan.

According to some aspects, the present disclosure relates to a computer-implemented method for user fall assessment, for a fall assessment environment, wherein the computer-implemented method comprises implementing a trained machine learning model, comprising an action plan, and inducement in accordance to the action plan.

According to some aspects, the inducement comprises actuations, and preventive measures, and correlates to, and/or reflects, fall assessment in relation to a user, and the fall assessment comprises fall detection, and computation of fall risk probability (FRP). The computer-implemented method comprises continuously obtaining of data, and continuously processing of data, where the computer-implemented method comprises continuous creation of information on basis of the obtained data and the processed data, continuous communication of the information, and fall assessment, in relation to a user. The fall assessment comprises fall detection, based on continuing data and on the continuing information, and continuous computation of FRP, based on the continuing data, fall risk indicators (FRI), and on the continuing information.

According to some aspects, the FRI comprises FRI:s such as “skidding”, “slipping”, “losing control”, “crashing with and/or hitting another object or vehicle”, “near-falls”, “stumbles during walk”, and/or “slips”. The fall assessment environment comprises the trained machine learning model being trained in user fall assessment, the user, sensors detecting data from the fall assessment environment, means for continuously obtaining data, means for processing data, means for creating the information on the basis of obtained data and processed data, means for communicating the information; and means for the inducement in accordance to the action plan and based on continuing data and based on the information.

According to some aspects, the trained machine learning model, during its implementation in the computer-implemented method for user fall assessment, continuously enables the continuous obtaining of data and the continuous processing of data, the continuous creation, and the continuous communication, of the information, the fall assessment, in relation to the user, comprising the fall detection and the continuous computation of FRP, and the inducement in accordance to the action plan.

According to some aspects, the trained machine learning model comprises a “computation of FRP machine learning module”, wherein the “computation of FRP machine learning module”, during said implementation of the trained machine learning model, enables the continuous computation of FRP, and the trained machine learning model further comprises a “management machine learning module”, wherein the “management machine learning module”, during said implementation of the trained machine learning model, enables management of the action plan.

According to some aspects, the management comprises validation, over time, of the action plan, wherein the validation is based on: the continuous computation of FRP, monitoring if, and how, the FRP changes, and, if set conditions for updating the action plan are fulfilled in the monitoring, updating the action plan.

According to some aspects, the computer-implemented method for user fall assessment further comprises the management of the action plan, wherein the management comprises the validation, over time, of the action plan, wherein the validation is based on: the continuous computation of FRP, the monitoring if, and how, the FRP changes, and, if set conditions for the updating the action plan are fulfilled in the monitoring, the updating of the action plan.

1. A computer-implemented method for user fall assessment, for a fall assessment environment, wherein the computer-implemented method comprises:
implementing a trained machine learning model, comprising an action plan;
continuously obtaining data, and continuously processing data;
fall assessment, in relation to a user;
validation, over time, of the action plan, wherein the validation is based on:
continuous computation of fall risk probability, FRP;
monitoring if, and how, the FRP changes; and,
if set conditions for the updating the action plan are fulfilled in the monitoring, updating the action plan,
wherein the fall assessment comprises fall detection, based on continuing data and on continuing information, and
wherein the continuously obtained data comprise data detected by sensors worn by the user and positioning data for the user, and where the computation of FRP also comprises said positioning data.

2. The computer-implemented method according to claim 1, wherein the computation of FRP also comprises environmental conditions, comprising weather conditions, at a determined position of the user.

3. The computer-implemented method according to claim 1, wherein the continuous computation of the FRP is based on the continuing data, continuing information and fall risk indicators (FRI), where the FRI's comprises at least one of “skidding”, “slipping”, “losing control”, “crashing with and/or hitting another object or vehicle”, “near-falls”, “stumbles during walk”, and/or “slips”, where the continuing information refers to the real time information such as data collected from sensors worn by the user as well historical information on geographical environments obtained from the positioning data.

4. The computer-implemented method according to claim 1, wherein the continuous computation of the FRP is based on the continuing data, continuing information and fall risk indicators (FRI), where the FRI:s comprises at least one of “skidding”, “slipping”, “losing control”, “crashing with and/or hitting another object or vehicle”, “near-falls”, “stumbles during walk”, and/or “slips”, where the continuing information refers to the real time information such as data collected from sensors worn by the user as well historical information on geographical environments obtained from the positioning data. and
wherein the continuing information refers to information regarding user age, physical and health profile.

5. The computer-implemented method according to claim 1, further comprising inducement in accordance with the action plan, wherein the inducement comprises actuations, and preventive measures, and correlates to, and/or reflects, fall assessment in relation to a user.

6. The computer-implemented method according to claim 1,
wherein the computer-implemented method comprises the management of the action plan, and
wherein the continuous computation of FRP further comprises computation of a first FRP, FRPt₁, at a first time, t₁, and computation of a second FRP, FRPt₂, at a second time, t₂, being later than said first time t₁,
the monitoring if, and how, the FRP changes, comprises determining a difference, Delta^{FRP}, between FRPt₁ and FRPt₂, and
if Delta^{FRP} is less than, or equal to, a set FRP threshold, then the action plan is valid, and if Delta^{FRP} is ; more than the set FRP threshold, then update the action plan.

7. The computer-implemented method according to claim 1,
wherein the computer implemented method comprises the management of the action plan, and
wherein the continuous computation of FRP further comprises computation of a first FRP, FRPt₁, at a first time, t₁, and computation of a second FRP, FRPt₂, at a second time t₂, being later than said first time t₁,
the monitoring if, and how, the FRP changes, comprises determining a difference Delta^{FRP}, between FRPt₁ and FRPt₂, and
if Delta^{FRP} is less than, or equal to, a set FRP threshold, then the action plan is valid, and _{if Delta}^{FRP} is more than the set FRP threshold, then update the action plan,
wherein the computer-implemented method comprises the management of the action plan, and
wherein, in the monitoring, if Delta^{FRP} exceeds the set FRP threshold, then the validation is also based on employing functional status data from the user obtained at the first time t₁ and at the second time t₂ and identify any anomaly scores of the functional status from the functional status data and if identified anomaly scores is less than, or equal to, a set anomaly threshold, then the action plan is valid, and
if the identified anomaly scores is more than the set anomaly threshold, then correlate the increased FRP with the identified anomaly scores of the functional status, and update the action plan.

8. The computer-implemented method according to claim 1, wherein the continuously obtained data comprise data from the fall detection.

9. The computer-implemented method according to claim Tony wherein the management of the action plan is a continuous and automatic management, and the computer-implemented method for user fall assessment comprises said management of the action plan, wherein the management of the action plan is a continuous management.

10. A computer program comprising computer readable instructions for applying the computer-implemented method according to claim 1, and/or a computer readable medium comprising said computer program.

11. A computer program according to claim 10, comprising computer readable instructions for implementing the trained machine learning model, and/or a computer readable medium comprising said computer program.

12. A control unit arrangement, for user fall assessment, adapted to control at least, enablement of: implementation of a trained machine learning model, the inducement in accordance to, and/or the management, of the action plan according to claim 9.

13. A device, e.g. a wearable device, for user fall assessment, for communication of information, for enabling implementation of a trained machine learning model, and for inducement in accordance to, and for enabling management, of the action plan according to claim 1,
wherein the inducement comprises actuations, and preventive measures,
wherein the fall assessment comprises fall detection and computation of FRP based on continuously obtained data and FRI, and wherein the FRI comprises FRI:s such as “skidding”, “slipping”, “losing control”, “crashing with and/or hitting another object or vehicle”, “near-falls”, “stumbles during walk”, and/or “slips”,
wherein the device comprises:
the trained machine learning model being trained in the user fall assessment and comprising an action plan,
sensor/s detecting data;
means for continuously obtaining data;
means for processing data;
means for creating the information on basis of obtained data and processed data; and
means for communicating the information;
wherein the device comprises a computer program comprising computer readable instructions for applying a computer-implemented method, and/or a computer readable medium comprising said computer program.

14-17. (canceled)

18. A device, e.g. a wearable device, for user fall assessment, for communication of information, for enabling implementation of a trained machine learning model, and for inducement in accordance to, and for enabling management, of the action plan according to claim 1;
wherein the inducement comprises actuations, and preventive measures,
wherein the fall assessment comprises fall detection and computation of FRP based on continuously obtained data and FRI, and wherein the FRI comprises FRI:s such as “skidding”, “slipping”, “losing control”, “crashing with and/or hitting another object or vehicle”, “near-falls”, “stumbles during walk”, and/or “slips”,
wherein the device comprises:
the trained machine learning model being trained in the user fall assessment and comprising an action plan;
sensor/s detecting data;
means for continuously obtaining data;
means for processing data;
means for creating the information on basis of obtained data and processed data; and
means for communicating the information,
wherein the device comprises a computer program comprising computer readable instructions for applying a computer-implemented method, and/or a computer readable medium comprising said computer program.

19. A system for user fall assessment, for communication of information, for enabling implementation of a trained machine learning model, and for inducement in accordance to, and for enabling management, of the action plan according to claim 1;
wherein the inducement comprises actuations, and preventive measures,
wherein the fall assessment comprises fall detection and computation of FRP based on continuously obtained data and FRI, and wherein the FRI comprises FRI:s such as “skidding”, “slipping”, “losing control”, “crashing with and/or hitting another object or vehicle”, “near-falls”, “stumbles during walk”, and/or “slips”,
wherein the system comprises:
a trained machine learning model being trained in the user fall assessment and comprising an action plan;
sensor/s detecting data;
means for continuously obtaining data;
means for processing data;
means for creating the information on basis of obtained data and processed data; and
means for communicating the information,
wherein the system comprises a computer program comprising computer readable instructions for applying a computer-implemented method, and/or a computer readable medium comprising said computer program.

20. A system for user fall assessment, for communication of information, for enabling implementation of a trained machine learning model, and for inducement in accordance to, and for enabling management, of the action plan according to claim 1;
wherein the inducement comprises actuations, and preventive measures,
wherein the fall assessment comprises fall detection and computation of FRP based on continuously obtained data and FRI, and wherein the FRI comprises FRI:s such as “skidding”, “slipping”, “losing control”, “crashing with and/or hitting another object or vehicle”, “near-falls”, “stumbles during walk”, and/or “slips”,
wherein the system comprises:
a trained machine learning model being trained in the user fall assessment and comprising an action plan,
sensor/s detecting data,
means for continuously obtaining data,
means for processing data,
means for creating the information on basis of obtained data and processed data, and
means for communicating the information;
wherein the system comprises a computer program comprising computer readable instructions for applying a computer-implemented method, and/or a computer readable medium comprising said computer program.

21. A piece of garment comprising the control unit arrangement according to claim 12, one or more sensors detecting data, and at least one airbag.
